(19) United States
(12) Patent Application Publication
(10) Pub. No.: US 2005/0243357 A1
(43) Pub. Date: Nov. 3, 2005

(54) Image output control device

(75) Inventor: Tsuyoshi Sugita, Tokyo (JP)

Correspondence Address: FRISHAUF, HOLTZ, GOODMAN & CHICK, PC, 220 5TH AVE FL 16, NEW YORK, NY, 10001-7708, US

(73) Assignee: Konica Minolta Medical & Graphic, Inc., Tokyo (JP)

(21) Appl. No.: 11/111,518

(22) Filed: Apr. 20, 2005

(30) Foreign Application Priority Data
Apr. 28, 2004 (JP) JP2004-133649

(51) Int. Cl. G06F 15/00

(52) U.S. Cl. 358/1.13; 358/471

(57) ABSTRACT

An image output control device, including a local bus, a central control section connected to the local bus, having, an image data conversion section for converting an image data, inputted from an outside of the image output control device, to a printing image data which is used when an exterior printing device prints out images, an interior transferring section for transferring the printing image data to a memory section so that the memory section stores the printing image data, and a transfer control section for outputting a control signal for transferring the printing image data in the memory section to the exterior printing device, the memory section connected to the local bus, for storing the printing image data, and the transfer section connected to the local bus, for receiving the control signal and transferring the printing image data in the memory section to the exterior printing device.

This application is based on Japanese Patent Application No. 2004-133649 filed on Apr. 28, 2004, in Japanese Patent Office, the entire content of which is hereby incorporated by reference.

### BACKGROUND OF THE INVENTION

The present invention relates to an image output control device which converts the image data inputted from the outside of the device and transfers it to a printer, and also controls the printing process being performed by the printer. Further, in order to optimize the output rate performance of the printer, the present invention relates to an image output control device structured so as to transfer the image data at a constant transfer rate.

In recent years, color laser printers are expected to be used in various fields due to their high quality of color-printed results as well as due to their high output rate. One effective example in a new field is that color laser printers are applied to output color proofs of color print correction in the fields of color printing business or photoengraving business. Though the color proof requires faithful color reproduction of the original color printed matter, printers providing only satisfactory color prints are presently produced.

Color laser printers are structured to receive the image data formed via an image output control device and perform the printing process via an image output control device. Patent document 1, described below, discloses one example of such image output control devices. The printer control device described in Patent document 1 includes a CPU, a system memory in which the image data are developed, a print interface control section for controlling image data, transferred from the system memory, so as to conform to the printing conditions, and for outputting image data to a printer, a means for developing the image data onto a continuous address area of the system memory. The print interface control section includes a temporary memory means for memorizing the image data, a means for carrying out DMA transfer to the temporary memory means, concerning the image data developed in the system memory, a data converting means for outputting the image data, inputted from the temporary memory means, to the printer by a single picture element unit, a temporary memory control means for carrying out the control, when the image data having an established line width are outputted from the temporary memory means to the data converting means, and a print output control means for controlling the output from the data converting means to the printer.

Specifically, the temporary memory means is structured by a FIFO (first-in first-out) memory.

If the image output control device cannot secure a high output rate by which the image data of each image are continuously transferred to the printer at a constant transfer rate, then a high speed printer cannot efficiently function at its high performance rate.

Further, since the image output control device carries out the process for converting post script (PS) image data to image data suitable for printer outputting, such as bitmap (BMP) type (hereinafter referred to as printing image data), the CPU in the image output control device has large processing load. Accordingly, in order to reduce the processing time, when the converting process of the image data as well as the transferring process of the printing image data is simultaneously performed, the CPU has a larger processing load, and it is very difficult to keep a constant transfer rate of the printing image data of each image.

Additionally, since the image output control device described in Patent Document 1 is structured in such a way that the transfer process of the printing image data to FIFO, being a temporary memory means, is performed as needed when a local bus is open, access frequency for an outer memory device is increased such as a hard disk, or for a system memory, resulting in an increase of frequency of use of the bus. Therefore, the frequency of use of the bus for controlling the transfer process to the printer is greatly limited, and it becomes more difficult to maintain a high transfer rate to the printer.

Patent Document 1: Unexamined Japanese Patent application Publication No. 6-344607

### SUMMARY OF THE INVENTION

The present invention has been achieved to counter the above conditions. An object of the present invention is to provide an image output control device which is able to transfer printing image data of each image to a printer at a constant transfer rate. The objective of the present invention can be attained by the structures described below.

Structure 1

An image output control device, including:
a local bus for transmitting various data,
a central control means including a CPU connected to the local bus,
a converting means, provided in the central control means, for converting image data, which are inputted from outside the image output control device, to printing image data which are printable by a printer,
a memory means, connected to the local bus, which stores the converted printing image data image by image,
an interior transferring means, provided in the central control means, for transferring the converted printing image data to the memory means image by image, to store the converted printing image data in the memory means,
a transfer control means, provided in the central control means, for outputting a control signal which requests transfer of the printing image data to the printer, and
a transfer means, connected to the local bus, for receiving the control signal, and for transferring the printing image data, stored in the memory means, to the printer by each single image unit (that is, the printing image data of a single page is transferred to the printer.).
   Structure 2

The image output control device in Structure 1, wherein the memory means includes plural memory sections, each storing the printing image data whose volume is equivalent to at least a single image, and the interior transfer means transfers the converted printing image data of a single image, to the memory section, after the printing image data whose volume is equivalent to a single image stored in the memory section are transferred to the printer.

Structure 3

The image output control device in Structure 2, wherein the interior transfer means transfers the printing image data to the plural memory sections in a predetermined order, and controls the plural memory sections to store the transferred printing image data, and the transfer means transfers the printing image data, stored in the plural memory sections, to the printer in the predetermined order.

Structure 4

The image output control device in Structure 1, wherein the memory means includes two memory sections, the interior transfer means alternately transfers the converted printing image data whose volume is equivalent to a single image, to each of the two memory sections, and controls the two memory sections to alternately store the transferred printing image data whose volume is equivalent to a single image, and further, the transfer means receives the control signal, and alternately transfers the printing image data stored in the two memory sections to the printer.

Structure 5

The image output control device in Structure 1, wherein the memory means stores the printing image data of at least one image, and the interior transfer means transfers the converted printing image data to the memory means, at a transfer rate equal to or greater than the transfer rate of the printing image data via the transfer means.

Structure 6

The image output control device in any one of Structures 1-5, further including a data storing means, connected to the local bus, for storing the printing image data converted via the converting means, wherein the interior transfer means transfers the converted printing image data to the data storing means so that the converted printing data are stored in the data storing means, and further, the stored printing image data are transferred to the memory means so that the converted printing data are stored in the memory means.

Structure 7

The image output control device in Structure 6, wherein the storing means is an exterior memory means.

Structure 8

The image output control device in any one of Structures 1-5, in which the converting means develops the image data in a predetermined system memory and converts the image data to the printing image data, and wherein the interior transfer means directly transfers the printing image data, converted in the system memory, to the memory means.

### BRIEF DESCRIPTION OF THE DRAWINGS

FIG. 1 is a schematic diagram of the total structure of an embodiment of an image output system including an image output control device related to the present invention.

FIG. 2 is a flow chart of a printing and plate making process carried out via an image output system including an image output control device of the present invention.

FIG. 3 is a block diagram showing the structure of a control system of an embodiment of an image output control device related to the present invention.

FIG. 4 is a flow chart showing an embodiment of a processing mode carried out via an image output control device of the present invention.

### DETAILED DESCRIPTION OF THE PREFERRED EMBODIMENTS

The embodiments of the image output control device related to the present invention will now be detailed referring to the drawings. Firstly, the structure of the image outputting system including the image output control device and the work flow employing the present system will be explained, after which the structure and the operation of the image output control device will be explained.

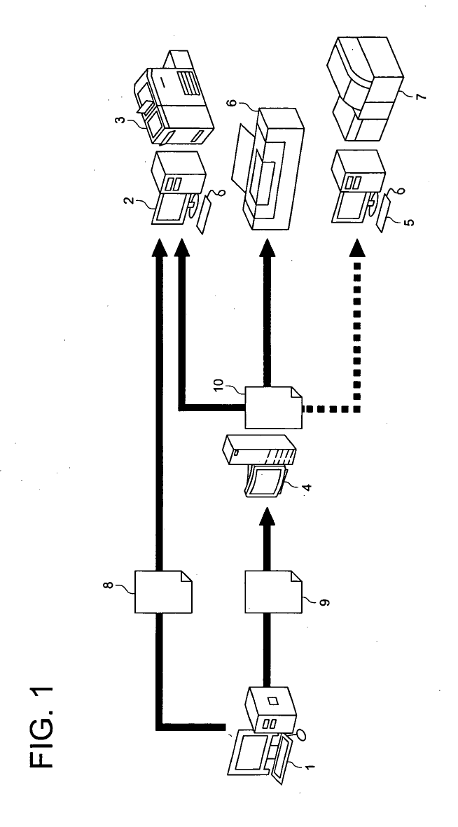

FIG. 1 shows a structure and work flow of an image output system including an image output control device. The image output system includes at least one set of client terminal 1, control device 2, color laser printer 3 (sometimes simply referred to as printer 3), RIP 4 used for CTP (which is raster image processor 4 used for the process of CTP, hereinafter referred to as “CTP-RIP 4”, CTP means “computer to plate”), DCP (digital color proof) control device 5, CTP 6 and DCP forming device 7, all of which are connected via a network.

Client terminal 1 is used for image editing (for example, pagination), and includes editing programs for image edition as well as an image inputting device, such as an image scanner. Client terminal 1 carries out the editing of image data (for “comprehensive”) 8, (which is the image data of a single page before the pagination, and the image data is used for the comprehensive.) formed of Post Script, as well as the editing of image data (for the final output) 9, formed of Post Script, is carried out in client terminal 1.

The term “comprehensive” means a color printed sample, in which the finished image of a photograph or an illustration is arranged on a page and printed out. A customer of the printed matter or a designer refers to the comprehensive, and checks the result of text correction or the quality of the color proof, or studies the design.

An operator of client terminal 1 can send edited image data (for the comprehensive) 8 to control device 2 to simply correct it. Further, to output a color proof of the corrections of the edited image data (for the final output) 9, or to perform CTP output process of the edited image data (for the final output) 9, the operator of client terminal 1 can send the image data (for the final output) 9 to CTP-RIP 4.

Control device 2 is a computer terminal structuring the image output control device related to the present invention, which conducts the process described below. Control device 2 conducts a RIP process, wherein the image data (for the comprehensive) 8, in the form of Post Script, sent from client terminal 1, is converted to a raster image data (which is bit map data, depending on the output resolution of printer 3). Further, control device 2 sends the raster image data and an output instructing signal to printer 3. The output instructing signal includes signals for indicating the output of raster image data, as well as signals for indicating the output surface on which the image based on the raster image data is outputted.

Color laser printer 3 outputs the image, which is based on the image data (for the comprehensive) 8 sent from control device 2, to the kind of outputting surface as the recording sheet designated by the output instructing signal. More definitely, printer 3 is a multi-function printer, providing a copying means of an electro-photographic method as well as an image inputting means, such as an image scanner, which incorporates plural sheet supply cassettes for storing various kinds of recording sheets. Printer 3 selects a sheet of recording media based on the output instructing signal sent from control device 2, and further, outputs the image based on the image data (for the comprehensive) 8 onto the output surface based on the output instructing signal.

CTP-RIP 4 conducts the RIP process on the image data (for the final output) 9, being a Post Script type, sent from client terminal 1, that is, the RIP process converts the image data (for the final input) 9 to the bit map data which corresponds to the output resolution of CTP 6 or DCP (digital color proof) forming device 7, after which, processor 4 sends rasterized image data 10 to CTP 6 or DCP control device 5. Additionally, when a high accuracy DCP is required, CTP-RIP 4 can send rasterized image data 10 to DCP control device 5.

DCP control device 5 controls the output process of the digital color proof produced by DCP forming device 7, based on rasterized image data 10 sent from CTP-RIP 4.

CTP (computer to plate) 6 directly outputs rasterized image data 10, sent from CTP-RIP 4, on a PS plate (which is a pre-sensitized plate).

DCP forming device 7 outputs a highly accurate DCP image based on rasterized image data 10 sent from CTP-RIP 4, via DCP control device 5.

Additionally, client terminal 1, control device 2, CTP-RIP 4 and DCP control device 5 are structured with the computer terminals respectively, which provide a computer, input devices, such as a mouse or a key board, and a display device, such as a monitor. The computers of each device incorporate the programs (application software) to perform the above processes.

Further, it is possible to form a structure in which rasterized image data 10, formed via CTP-RIP 4, are sent to control device 2, after which printer 3 outputs the image based on rasterized image data 10. Due to the above, a simplified DCP based on rasterized image data 10 can be outputted. In this case, it is preferable that control device 2 includes a means for determining whether the inputted image data have been rasterized, and a means for transferring the rasterized image data to printer 3, wherein the rasterized image data are transferred to the printer 3, while not yet-rasterized image data are transferred after they are rasterized.

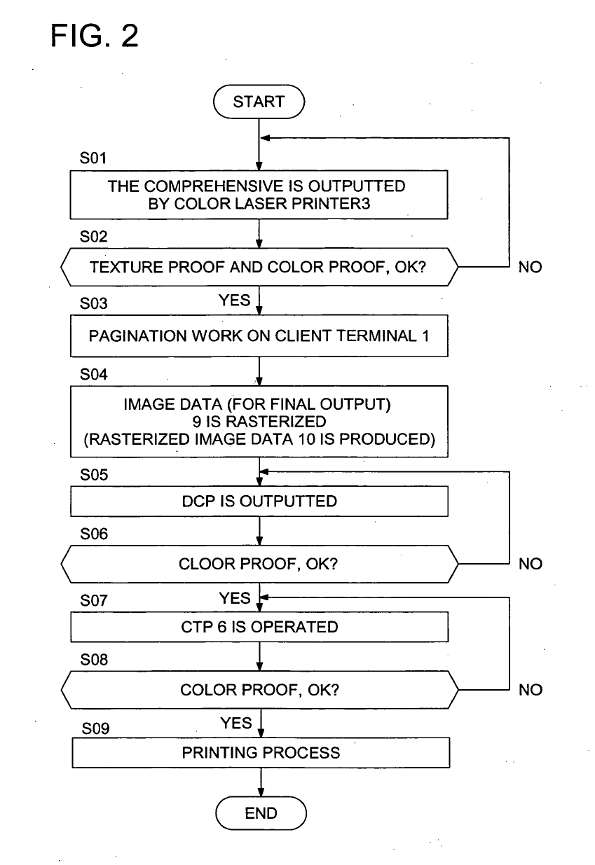

FIG. 2 is a flow chart of the image output system. Firstly, the comprehensive is outputted by laser printer 3 (S01). To be more precise, after the image data, edited via client terminal 1, are sent to control device 2, control device 2 converts the image data to the rasterized image data via the RIP process, after which, control device 2 sends the rasterized image data and the output instructing signal to color laser printer 3. Printer 3 outputs the image on the recording sheet based on the output instructing signal, that is, the comprehensive is produced.

When the customer or the designer finds no errors (S02, YES), the operator of the print company performs a pagination operation via client terminal 1 (S03). The “Pagination operation” means the operation wherein after a pre-press film is printed on a sheet, and when a sheet is folded, photographs or illustrations are arranged and adhered on the folded sheet so that the page numbers of each sheet are serialized.

When the paginated image data, which is image data (for the final output) 9 are sent from client terminal 1 to CTP-RIP 4, CTP-RIP 4 conducts the RIP process on image data (for the final output) 9 and creates the raster image data (which is rasterized image data 10) (S04).

Next, DCP is outputted based on rasterized image data 10 (S05). Concerning the DCP formed in this step, one is a simple DCP formed by printer 3 described above, and the other is a high precision DCP formed by DCP forming device 7. When the simple DCP is produced by printer 3, rasterized image data 9 are sent from CTP-RIP 4 to control device 2. Control device 2 sends rasterized image data 9 as well as the output instructing signal to printer 3, which outputs the image based on rasterized image data 10 according to the output instructing signal. On the other hand, when a high precision DCP is formed by DCP forming device 7, CTP-RIP 4 sends rasterized image data 10 to DCP control device 5. DCP control device 5 activates DCP forming device 7 to output the image, based on rasterized image data 10.

The customer of the print or the designer conducts color proofing of rasterized image data 10, that is, image data (for final output) 9, referring to the outputted DCP. When there is no problem (YES in S06), the customer of the print or the designer sends rasterized image data 10 from CTP-RIP 4 to CTP 6, after which CTP 6 prints out the image directly onto a printing plate. Further, the operator of the printing company creates the printed matter based on the printing plate, and performs the color proofing of the printed matter. When there is no problem (YES in S08), a printing machine, which is not illustrated, produces the printed matter (S09).

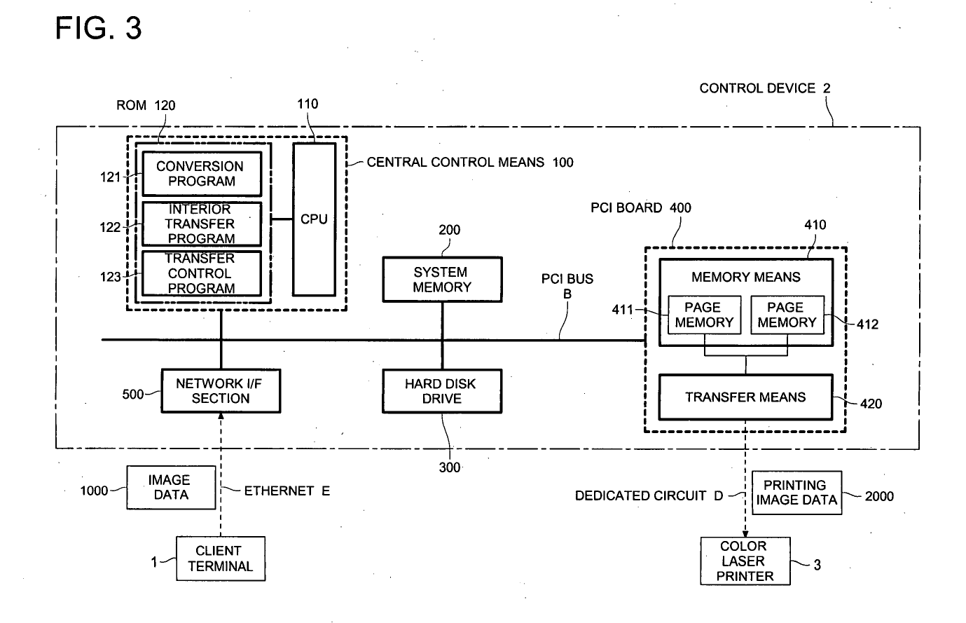

Control device 2 of the image output control device of the present invention will be explained below. The block diagram in FIG. 3 shows a structure of control device 2.

Client terminal 1 and control device 2 are connected to each other by a LAN, such as Ethernet (a registered trademark). Control device 2 and color laser printer 3 are typically connected to each other by dedicated circuit D.

As shown in FIG. 3, control device 2 includes central control means 100, system memory 200, hard disk drive 300 as an outer memory device, PCI board 400, and network interface (I/F) section 500, all of which are extended on PCI bus (peripheral components interconnect bus) B as a local bus.

Central control means 100 includes ROM 120 and CPU 110 to execute various programs. ROM 120 stores conversion program 121, interior transfer program 122, and transfer control program 123. Additionally, it is also possible to store these programs in a nonvolatile storage, such as hard disk drive 300, to which CPU 110 has access to execute an objective program.

CPU 110 works as the conversion means of the present invention. That is, CPU 110 executes the RIP process via conversion program 121 so that image data 1000, sent from client terminal 1 via the communication lines, such as Ethernet, is converted to rasterized image data 10. Additionally, rasterized image data 10 is a bitmap image data to be processed in the printing process by color laser printer 3, which corresponds to the printing image data of the present invention. Rasterized image data 10 will be referred to as printing image data 2000 (see FIG. 3).

Further, CPU 110 functions as the interior transfer means of the present invention. That is, CPU 110 executes interior transfer program 122 so that the transfer process of image data 1000 and printing image data 2000, in control device 2, are performed. To be more precise, CPU 110 executes the transfer process of image data 1000 among system memory 200, hard disk drive 300, and memory means 410 on PCI board 400 (to be described later). Specifically, when CPU 110 transfers printing image data 2000 from hard disk drive 300 to memory means 400, CPU 110 alternately transfers printing image data 2000 to both image memories 411 and 412 in memory means 410.

Yet further, CPU 110 functions as the transfer control means of the present invention. That is, CPU 110 executes transfer control program 123 so that the control signal, for requesting the transfer of printing image data 2000 to printer 3, is outputted. The control signal is sent to transfer means 420 on PCI board, which is detailed later.

System memory 200 is a memory device, such as a RAM, on which the various programs, by which CPU 110 executes the various processes, and image data 2000 are developed. Specifically, CPU 110, serving as the conversion means, develops image data 1000 on system memory 200, and thereby, CPU 110 executes the RIP process for converting image data 1000 into printing image data 2000.

Hard disk drive 300 structures the storing means of the present invention, and stores printing image data 2000 formed by CPU 110 which serves as the conversion means. For the storing means, it is possible to employ an exterior memory device which may be hard disk drive 300 or a DVD-RAM, as well as other memory devices which are data-writable.

PCI board 400 is an interface board, compliant with PCI bus B which is standardized to extend the function of the device. Memory means 410 and transfer means 420 are provided within PCI board 400 of the present embodiment.

Memory means 410 includes page memories 411 and 412, each having enough memory capacity so that printing image data 2000, whose volume is equivalent to a single image, can be stored. The page memory used for memory means 410 can also be one having enough memory capacity in which the volume of plural images can be stored. The number of the page memory devices provided in memory means 410 is not limited to two, that is, one or more than three devices is possible (which will be detailed later). Page memories 411 and 412 structure the memory section of the present invention.

Transfer means 420 alternately transfers printing image data 2000, whose volume is equivalent to a single image, from page memories 411 and 412 to color laser printer 3. Transfer means 420 receives the control signals from CPU 110 which serves as the transfer control means, and performs the transfer process of printing image data 2000. Further, transfer means 420 transfers printing image data 2000 to color laser printer 3 at a predetermined transfer rate.

Network I/F section 500 is an input-output interface which performs input-output operations of the image data between client terminal 1 and control device 2.

The operation of control device 2, structured as described above, will now be detailed, and at the same time, the operations of each section of the control device 2 will be detailed.

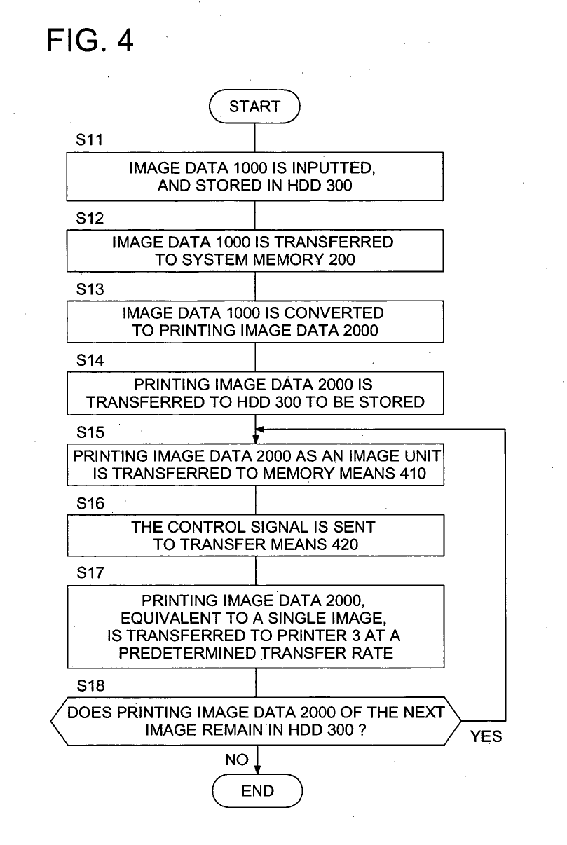

In FIG. 4, when image data 2000 has been inputted from client terminal 1, network I/F section 500 stores image data 1000 into a predetermined directory of hard disk drive (HDD) 300 (S11). Inputted image data 1000 includes the image data of the plural images (that is, image data of plural pages).

CPU 110 executes interior transfer program 122 to transfer image data 1000 (or a copy of image data 1000) stored in hard disk drive 300 to system memory 200 (S12). CPU 110 can transfer the data of plural images at one time in accordance with the memory capacity of system memory 200, or can transfer the data of a single image individually.

Next, in order to convert image data 1000, transferred to system memory 200, to printing image data 2000, via RIP process (S13), CPU 110 executes conversion program 121. Printing image data 2000, created via the above process, are transferred to hard disk drive 300 via CPU 110 which executes interior transfer program 122, and are stored in each directory allocated for each image (S14).

Additionally, the directories for storing printing image data 2000 corresponding to each image are arrayed in an order of pages of the images. The array of storage directories (array setting information) is stored in hard disk drive 300 with a table form. CPU 110, serving as the interior transfer means, can transfer the data of plural images, or can sequentially transfer each image chosen from the rasterized image data.

Hereinafter, a one image volume, a two image volume, a three image volume, etc, of printing image data 2000, are referred to as “an image unit”. That is, “an image unit” means the data is divided into a single image or plural images. Accordingly, for example, printing image data 2000, whose volume is equivalent to 1.5 images, is not the image unit mentioned above.

CPU 110, serving as the interior transfer means, transfers printing image data 2000, stored in hard disk drive 300, to memory means 410 AS an image unit. To be more precise, CPU 110 refers to the above-mentioned array setting information, and obtains the directory in which printing image data 2000 corresponding to a targeted image, such as an image of the first page, is stored, after which printing image data 2000 is transferred from hard disk drive 300 to memory means 410, such as page memory 411.

In this way, when printing image data 2000 is sequentially transferred to memory means 410 as an image unit, though relating to the condition, such as the transfer rate to printer 3, it often happens that the data are stored in both page memories 411 and 412. Further, when the RIP process takes a long time, due to a large amount of image data 1000, and when the image data are sequentially transferred from client terminal 1, CPU 110 has a large processing load, because CPU 110 must simultaneously perform the operation of RIP process as well as the control of the transfer process to printer 3. Due to this, for a conventional image output control device, it is very difficult to transfer printing image data 2000 to printer 3 at a predetermined transfer rate. Accordingly, it is difficult to effectively utilize the output rate performance of printer 3. Control device 2 of the present embodiment overcomes such problems by using the process described below. Hereinafter, it is assumed that printing image data 2000, whose volume is equivalent to a single image, has been stored in both page memories 411 and 412.

CPU 110 executes transfer control program 123, by which a control signal to request the transfer of printing image data 2000, stored in memory means 410, to printer 3, is sent to transfer means 420 (S16). Based on that control signal, transfer means 420 transfers printing image data 2000 whose volume is equivalent to a single image, stored in page memory 411, to printer 3 at a predetermined transfer rate (S17). Thereafter, page memory 411 is empty, while page memory 412 stores printing image data 2000 whose volume is equivalent to a single image.

CPU 110, serving as the interior transfer means, checks the directory of hard disk drive 300, and if printing image data 2000 of the image of the next page has been stored in hard disk drive 300 (YES in S18), CPU 110 transfers printing image data 2000 of the image of the next page to page memory 411 (S15). Further, CPU 110, serving as the transfer control means, transfers the control signals to transfer means 420 (S16). Transfer means 420 receives the control signals, and transfers printing image data 2000 whose volume is equivalent to a single image, stored in a different page memory (which is page memory 412 in this case), to printer 3 at a predetermined transfer rate (S17). Thereby, page memory 411 stores printing image data 2000 whose volume is equivalent to a single image, whereby page memory 412 becomes empty.

If printing image data 2000 of a next image remains in hard disk drive 300 (YES in S18), CPU 110, serving as the interior transfer means, transfers any remaining printing image data 2000 to empty page memory 412 (S15), and CPU 110, serving as the transfer control means, sends the control signals to transfer means 420 (S16). Transfer means 420 receives the control signals, and transfers printing image data 2000, whose volume is equivalent to a single image, stored in different page memory 411, to printer 3 at a predetermined transfer rate (S17). The above-described processes are repeated until printing image data 2000 of all images (pages) stored in hard disk drive 300 are completely transferred to printer 3 (NO in S18).

On the above processes, produced printing image data 2000 as a single image is alternately transferred to page memories 411 and 412 via hard disk drive 3, and printing image data 2000 stored in page memories 411 and 412 are alternately transferred to printer 3.

According to control device 2 of the present embodiment which performs the above processes, in order to transfer printing image data 2000, whose volume is equivalent to a single image, to printer 3, if only CPU 110 transfers the control signals requesting the transfer process, to transfer means 420, the actual transfer process is performed by transfer means 420, and thereby, the processing amount used for transferring the data to printer 3 can be reduced. Therefore, according to control device 2 of the present embodiment, even while RIP is processed onto image data 2000, printing image data 2000 can be transferred to printer 3 at a predetermined rate.

Yet further, control device 2 of the present embodiment is structured in such a manner that the page memories as memory means 410 are provided, into which printing image data 2000 is transferred as a single image unit and memorized. Comparing to the conventional printer device of Patent Document 1, wherein the data are transferred to the FIFO as needed, and the frequency of use of the local bus increases, though the present embodiment does not have such drawbacks. Accordingly, the transfer rate of printing image data 2000 to printer 3 can be stably maintained and increased.

Variations are described below. In the above-described embodiment, printing image data 2000 formed in system memory 200 is initially stored in hard disk drive 300, and then transferred to memory means 410, however, printing image data 2000 can be directly transferred from system memory 200 to memory means 410. In this case, in order to transfer printing image data 2000 to printer 3, CPU 110 only sends the control signals to request the transfer of printing image data 2000 to transfer means 420. Additionally, it is possible to form a structure in which an indirect transfer mode which transfers via the hard disk drive, and a direct transfer mode of this variation, are selected. For this selecting operation, input devices, such as a key board or a mouse of control device 2, can be employed.

If there are three or more units of page memories in memory means 410, the transfer order to the page memory controlled by CPU 110 which serves as the interior transfer means, and the transfer order to printer 3 controlled by transfer means 120, should be previously established. Generally, if N units of page memories 1, 2, - - - , and N, are structured, CPU 110, serving as the interior transfer means, can set the transfer order to transfer the printing image data stored in hard disk drive 300 to page memories 1, 2, - - - , and N in this numbering order, and further, transfer means 420 can set the transfer order to transfer the printing image data to printer 3, in accordance with the order of the printing image data stored in page memory 1, the printing image data stored in page memory 2, - - - , and the printing image data stored in page memory N. The above-described transfer order corresponds to the predetermined order described in the present invention.

In order to simplify hardware construction, memory means 410 is structured with a single page memory, which offers two cases. In the first case, a single page memory is employed as memory means 410, which has the memory capacity for storing printing image data 2000 of at least a single image. CPU 110, serving as the interior transfer means, and transfer means 420 transfer printing image data 2000 of the single page memory (memory means 410) via the timing described below.

Firstly, CPU 110, serving as the interior transfer means, transfers printing image data 2000, whose volume is equivalent to a single image, produced via the RIP process, to memory means 410 via hard disk drive 300, and stores it in memory means 410. CPU 110, serving as the transfer control means, outputs the control signals to transfer means 420. Transfer means 420 receives the control signals, and transfers printing image data 2000 stored in memory means 410 to printer 3. That is, memory means 410 creates an empty area corresponding to printing image data 2000 of at least a single image. Next, CPU 110, serving as the interior transfer means, transfers printing image data 2000 of the next single image to memory means 410. The same procedures as above are repeated, and thereby the storing process of printing image data 2000 into memory means 410, as well as the transfer process of printing image data 2000 to printer 3 is alternately performed.

The transfer rate via CPU 110 serving as the interior transfer means is equal to or greater than the transfer rate via transfer means 120, which is preferable. This is because if the transfer process to memory means 410, which functions as a buffer means, is performed at the same or greater rate of the transfer process from memory means 410 to printer 3, printing image data 2000 is transferred to memory means 410 without delay as data transfer to printer 3, and thereby, the total processing time can be shortened. Additionally, “transfer rate” means the amount of data which can be transferred within one second (bps: bits per second).

Next, in the second case, a page memory with enough memory capacity for storing plural images is provided as memory means 410, and the page memory is divided into plural memory areas. The memory capacity of each memory area is structured to store printing image data 2000 of at least a single image. Further, each memory area is treated as a single page memory to be processed in the same manner as the above embodiment. The plural memory areas are recognized by each directory.

For example, the page memory, having the enough memory capacity for storing printing image data of two images, is provided as memory means 410, and the page memory is equally divided into two memory areas (which are a first and a second memory area) for processing. Namely, each of first and second memory area has the memory capacity which is capable of storing printing image data 2000 whose volume is equivalent to a single image. The first memory area is designated as page memory 411, and the second memory area is designated as page memory 412, for which the same processing as in the above embodiment is performed. Each memory area of the page memories corresponds to the memory section of the present invention.

As described above, even when memory means 410 has been structured as a single page memory, CPU 110 only sends control signals to transfer means 420 for transferring printing image data 2000 to printer 3, and transfer means 420 performs the transfer process after receiving appropriate control signals. Accordingly, even while CPU 110, serving as the transfer means, executes the RIP process, printing image data 2000 can be effectively transferred to printer 3.

In the above-described embodiments, image data 1000 is inputted from client terminal 1 to control device 2, however, the input of the image data to the printer control section of the present invention is not limited to the above description, and any appropriate inputting feature can be employed. For example, structured is a means to read a memory medium, such as CD-ROM or DVD-ROM, on the image output control device, and thereby, the image data stored in the memory medium, is read and inputted to the image output control device.

The above structure shows examples of the preferable embodiments suitable for the image output control device relating to the present invention. Accordingly the described contents concerning the present invention can be modified as long as it remains within the scope of the present invention.

According to the image output control device of the preset invention, in order to transfer the printing image data to the printer, the CPU transfers only the control signals requesting the transfer process, to transfer means, and thereby, the actual transfer process is performed by the transfer means, and thereby, the processing amount used for transferring the data to the printer can be reduced. Further, independently of the workload of the image data conversion process, it is possible to transfer the printing image data to the printer at a predetermined transfer rate.

1. An image output control device, comprising:
a local bus on which various data are transferred;
a central control section connected to the local bus, including,
an image data conversion section for converting an image data, inputted from an outside of the image output control device, to a printing image data which is used when an exterior printing device located in an outside of the image output control device prints out an image,
an interior transferring section for transferring the printing image data for each image to a memory section so that the memory section stores the printing image data, and
a transfer control section for transferring a control signal to the transfer section, in which the control signal orders the transfer section to transfer the printing image data in the memory section to the exterior printing device;
the memory section connected to the local bus, for storing the printing image data for each image; and
the transfer section connected to the local bus, for receiving the control signal and transferring the printing image data for each image stored in the memory section to the exterior printing device.

2. The image output control device in claim 1, wherein the memory section includes plural memory sections, each storing the printing image data of at least a single image, and the interior transfer section transfers the printing image data of a single image, to the memory section, after the printing image data of a single image stored in the memory section was transferred to the exterior printing device.

3. The image output control device in claim 2, wherein the interior transfer section transfers the printing image data to the plural memory sections in a predetermined order, and controls the plural memory sections to store the printing image data, and the transfer section transfers the printing image data stored in the plural memory sections, to the exterior printing device in the predetermined order.

4. The image output control device in claim 1, wherein the memory section includes two memory sections, the interior transfer section alternately transfers the printing image data of a single image to each of the two memory sections, and controls the two memory sections to alternately store the printing image data of a single image, and after the transfer section receives the control signal, the transfer section alternately transfers the printing image data stored in the two memory sections to the exterior printing device.

5. The image output control device in claim 1, wherein the memory section stores the printing image data of at least one image, and the interior transfer section transfers the printing image data to the memory section, at a transfer rate equal to or greater than the transfer rate of the printing image data via the transfer section.

6. The image output control device in claim 1, further comprising a data storing section, connected to the local bus, for storing the printing image data converted via the conversion section, wherein the interior transfer section transfers the converted printing image data to the data storing section so that the converted printing image data is stored in the data storing section, and further, the stored printing image data is transferred to the memory section so that the converted printing image data is stored in the memory section.

7. The image output control device in claim 6, wherein the storing section is an exterior memory section.

8. The image output control device in claim 1, in which the conversion section develops the image data in a predetermined system memory and converts the image data to the printing image data, and wherein the interior transfer section directly transfers the printing image data, converted in the system memory, to the memory section.
